(19) United States
(12) Patent Application Publication
(10) Pub. No.: US 2014/0367301 A1
(43) Pub. Date: Dec. 18, 2014

(54) APPARATUS FOR INDICATING INSERTION OF MEDICINE, MEDICINE INSERTION APPARATUS, AUTO-PACKAGING APPARATUS HAVING THE SAME AND MEDICINE INSERTION AREA INDICATION METHOD THEREOF

(71) Applicant: JVM CO., LTD., Dalseo-gu (KR)

(72) Inventor: Jun Ho KIM, Suseong-gu (KR)

(21) Appl. No.: 14/306,900

(22) Filed: Jun. 17, 2014

(30) Foreign Application Priority Data
Jun. 18, 2013 (KR) 10-2013-0069437
Jun. 18, 2013 (KR) 10-2013-0069438

(51) Int. Cl. A61J 1/03; B65B 5/08

(52) U.S. Cl. CPC A61J 1/03; B65B 5/08
USPC 206/534; 53/473

(57) ABSTRACT

Provided are an apparatus for indicating insertion of medicines, a medicine insertion apparatus, an auto-packaging apparatus having the same, and a medicine insertion area indication method thereof. The apparatus for inserting medicines includes a plurality of medicine insertion slots and an area indicator configured to indicate an area including at least one medicine insertion slot among the plurality of medicine insertion slots, wherein the area indicator comprises at least two unit indicators which indicates the area in combination. According to the present invention, the medicine accepting units or medicine inserting slots in which medicines are inserted are divided into predetermined areas to previously prevent the medical accident such as the packaging error from occurring.

### CROSS-REFERENCE TO RELATED PATENT APPLICATION

This application claims the benefit of Korean Patent Application No. 10-2013-0069437, filed on Jun. 18, 2013 and Korean Patent Application No. 10-2013-0069438, filed on Jun. 18, 2013, in the Korean Intellectual Property Office, the disclosure of which is incorporated herein in its entirety by reference.

### BACKGROUND OF THE INVENTION

1. Field of the Invention

The present invention relates to an apparatus for indicating insertion of medicines, a medicine insertion apparatus, an auto-packaging apparatus having the same, and a medicine insertion area indication method thereof, and more particularly, to an apparatus that is capable of accurately and simply distributing medicines according to a patient's prescription.

2. Description of the Related Art

In general, medicine auto-packaging apparatuses may be apparatuses for simultaneously or independently auto-packaging medicines accepted in a medicine cassette and medicines that is not capable of being accepted in the medicine cassette by a single-dose amount.

Medicines accepted in a medicine cassette may be stored at a predetermined position within a medicine auto-packing apparatus in quantity and then automatically distributed as necessary. However, medicines, that is not capable of being accepted in the medicine cassette, such as drugs may be mounted within the medicine auto-packing apparatus and then automatically distributed after a tray for distributing medicines is separately prepared. That is, medicines that is not capable of accepted in the medicine cassette has to be passively previously distributed onto a tray artificially by a user such as a pharmacist.

When the medicines are passively distributed as described above, the user such as the pharmacist may have to confirm the medicine distributed on the tray one by one. If it is determined that the distribution is normal after the confirmation, the tray may be inserted into the medicine auto-packaging apparatus and then operate the medicine auto-packaging to supply and package the medicines within the medicine cassette and the medicines distributed onto the tray by singe-dose amount.

The distribution of the medicines onto the tray may be realized by the user such as the pharmacist as described above. However, accuracy in distribution may be essentially reduced on characteristics of the passive action. Thus, even though the distribution of the medicines onto the tray is completed, an additional confirmation process is required always. Thus, work efficiency may be reduced. Also, even though the user such as the pharmacist confirms whether the medicines are accurately distributed, it may be difficult to confirm the distribution of the medicines through a naked eye thereof. Thus, the smallest on the distribution mistake could lead to a mistake in package of the medicines, thereby damaging patient healthy due to medication dosing errors.

### SUMMARY OF THE INVENTION

The present invention provides a means that is capable of minimizing a packaging error when medicines are manually distributed by a pharmacist.

The present invention also provides a means that is capable of minimizing the number of recognizing and determining processes that are required for recognizing a medicine accepting unit in which medicines has to be accepted and a medicine accepting unit in which medicines has not to be accepted.

The technical objects of the present invention are not limited to those described above, and it will be apparent to those of ordinary skill in the art from the following description that the present invention includes other technical objects not specifically mentioned herein.

According to an aspect of the present invention, there is provided an apparatus for inserting medicines, the apparatus including: a plurality of medicine insertion slots; and an area indicator configured to indicate an area including at least one medicine insertion slot among the plurality of medicine insertion slots, wherein the area indicator comprises at least two unit indicators which indicates the area in combination.

The area indicator may indicate at least one area defined by the adjacent medicine insertion slots of the plurality of medicine insertion slots along an outer line of each of the areas.

The area indicator may include at least one of the unit indicators disposed on borders between the medicine insertion slots.

At least one of the unit indicators may be disposed between intersection points adjacent to each other among intersection points at which the borders cross or contact each other.

The unit indicator may include each of the unit indicators adjacent to each of the intersection points.

The plurality of medicine insertion slots may be divided for patients and taking periods.

The apparatus may further include a control unit determines the medicine insertion slots, in which specific medicines are inserted, of the plurality of medicine insertion slots according to patient's prescription date transmitted from an external device and control the area indicator to indicate areas of the determined medicine insertion slots.

The control unit may control the indicating unit to indicate the areas, in which the specific medicines are inserted with respect to the plurality of patients, at the same time.

The unit indicator may include a light emitting device.

According to another aspect of the present invention, there is provided an apparatus for auto-packaging medicines, the apparatus including: a medicine insertion apparatus configured to include a plurality of medicine insertion slots and an area indicator configured to indicate an area including at least one medicine insertion slots among a plurality of medicine insertion slots, wherein the area indicator comprises at least two unit indicators which indicates the area in combination; a transferring unit configured to transfer the medicines inserted in the medicine insertion apparatus; and a packaging unit configured to package the medicines transferred by the transferring unit.

According to a further aspect of the present invention, there is provided an apparatus for indicating, among a plurality of medicine accepting units which are included in a medicine insertion apparatus, at least one medicine accepting unit to which medicines are to be inserted, the apparatus including: an indicating apparatus body unit configured to be disposed on the apparatus; a plurality of medicine insertion slots configured to be formed at the indicating apparatus body unit and to be formed to respectively correspond to each of the plurality of medicine accepting units when the indicating apparatus body unit disposes on a medicine tray; and an area indicator configured to indicate an area including at least one medicine insertion slot among the plurality of medicine insertion slots, wherein the area indicator comprises at least two unit indicators which indicates the area in combination.

The area indicator may indicate at least one area defined by the adjacent medicine insertion slots of the plurality of medicine insertion slots along an outer line of each of the areas.

The indicating unit may include at least one of the unit indicators disposed on borders between the medicine insertion slots.

At least one of the unit indicators may be disposed between intersection points adjacent to each other among intersection points at which the borders cross or contact each other.

At least one of the unit indicators may be located adjacent to each of the intersection points.

The apparatus may further include a control unit determines the medicine insertion slots, in which specific medicines are inserted, of the plurality of medicine insertion slots according to patient's prescription date transmitted from an external device and controls the area indicator to indicate areas of the determined medicine insertion slots.

According to a further another aspect of the present invention, there is provided a method for indicating a medicine insertion area, the method includes: determining, among a plurality of medicine accepting units which are included in a medicine insertion apparatus, at least one medicine accepting unit to which a specific medicine is to be inserted based on patient prescription data; discriminating at least one area including at least one medicine accepting unit which are adjacent to each other from the determined at least one medicine accepting unit; determining at least one medicine accepting unit which is placed nearby a border of the determined area; and indicating the determined area using an area indicator placed on a border of the at least one medicine accepting unit which is placed nearby a border of the determined area.

In the indicating of the determined area, the borders of the determined areas may be continuously or discontinuously indicated by using the area indicator.

In the indicating of the determined area, angular points of the borders of the determined areas may be indicated by using the area indicator.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating a medicine insertion apparatus according to an embodiment of the present invention;

FIG. 2 is a plane view illustrating the medicine insertion apparatus according to an embodiment of the present invention;

FIGS. 3 and 4 are schematic view illustrating an operation example of the medicine insertion apparatus according to an embodiment;

FIG. 5 is a plane view illustrating the medicine insertion apparatus according to another embodiment;

FIG. 6 is a perspective view illustrating a medicine insertion indicating apparatus according to an embodiment;

FIG. 7 is an exploded perspective view of a medicine insertion indicating apparatus according to another embodiment;

FIG. 8 is a perspective view illustrating a use state of the medicine insertion indicating apparatus of FIG. 7;

FIG. 9 is a perspective view of a medicine auto-packaging apparatus according to an embodiment;

FIG. 10 is a block diagram of the medicine insertion apparatus according to an embodiment;

FIG. 11 is a flowchart illustrating a method for indicating a medicine insertion area according to an embodiment;

FIG. 12 is a perspective view of the medicine insertion indicating apparatus according to an embodiment;

FIG. 13 is a perspective view of the medicine insertion indicating apparatus and a medicine tray according to an embodiment;

FIG. 14 is a perspective view illustrating a state in which the medicine insertion indicating apparatus is coupled to the medicine tray according to an embodiment;

FIGS. 15 and 16 are perspective views illustrating a state in which the medicine insertion indicating apparatus is coupled to the medicine tray provided in the medicine auto-packaging apparatus according to an embodiment;

FIG. 17 is a perspective view of a medicine insertion indicating apparatus including a sensed unit according to another embodiment;

FIG. 18 is a bottom perspective view of the medicine insertion indicating apparatus of FIG. 17;

FIGS. 19 and 20 are perspective views illustrating a state in which the medicine insertion indicating apparatus of FIG. 17 is seated on the medicine tray that corresponds thereto:

FIG. 21 is a perspective view illustrating a sate in which the medicine insertion indicating apparatus of FIG. 17 is seated on the medicine tray in a different direction; and

FIG. 22 is a block diagram illustrating an electrical constitution and a connection relationship of the medicine insertion indicating apparatus according to an embodiment.

### DETAILED DESCRIPTION OF THE INVENION

Hereinafter, embodiments of the present invention will be described with reference to the accompanying drawings. Unless a specific definition or reference is provided, the term that represents a direction used in the current description may be based on a state illustrated in the drawings. Also, the same reference numeral indicates the same member throughout. Also, in the figures, the dimensions of layers and regions are exaggerated for clarity of illustration. In actual, this does not mean that each of components has to have a corresponding dimension or a rate between the components.

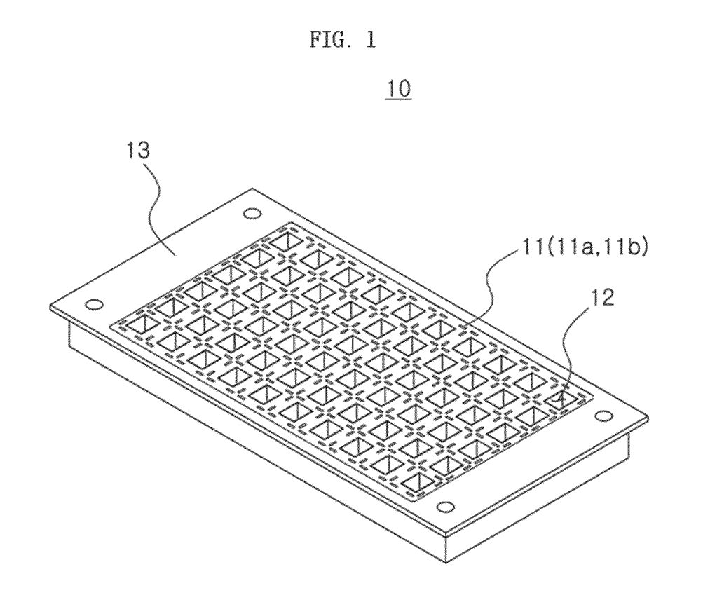

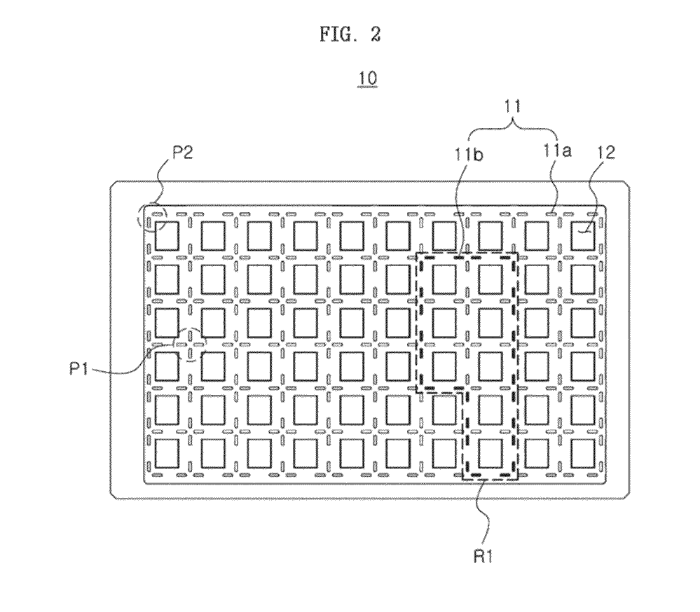

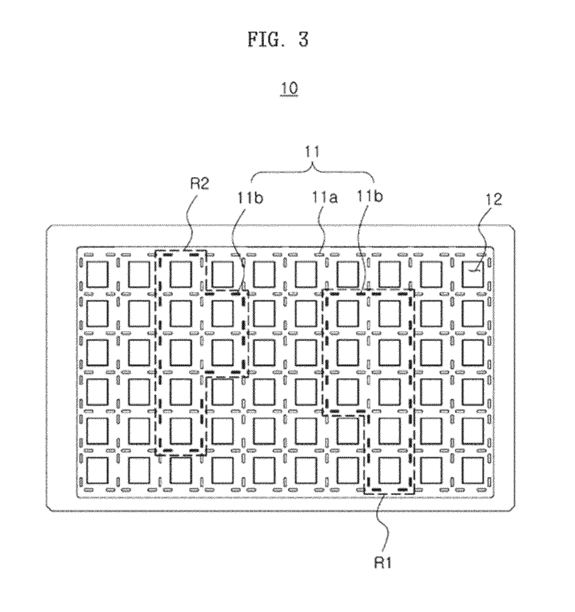

A medicine insertion apparatus according to an embodiment of the present invention will be described with reference to FIG. 1 to 4. FIG. 1 is a perspective view illustrating a medicine insertion apparatus according to an embodiment of the present invention, FIG. 2 is a plane view illustrating the medicine insertion apparatus according to an embodiment of the present invention, and FIGS. 3 and 4 are schematic view illustrating an operation example of the medicine insertion apparatus according to an embodiment.

Referring to FIG. 1, a medicine insertion apparatus 10 according to the current embodiment includes an insertion apparatus body unit 13, a medicine accepting unit 12, and an area indicator 11.

The insertion apparatus body unit 13 has a plate shape with a predetermined thickness. The insertion apparatus body unit 13 includes a plurality of medicine accepting units 12 each of which is recessed downward from an upper portion thereof. Although the medicine accepting units 12 according to the current embodiment are arranged in 6×10 matrix form, the present invention is not limited thereto. For example, the medicine accepting units 12 may be arranged in various shapes.

Each of the medicine accepting units may be a unit for accepting medicines and be divided according to various references. For example, the medicine accepting unit 12 may be divided according to medicines that are taken to a specific patient for each date at morning, lunch, and evening. The division of the medicine accepting units 12 may be variously set in addition to patients and taking periods.

The area indicator may indicate one or more medicine accepting units 12 adjacent to each other by a combination of at least two unit indicators. For example, the unit indicators 11a, 11b may be LED devices for converting turn-on/off states according to an electrical signal for controlling whether a power is supplied or supplying of a power. Hereinafter, for convenience of descriptions, an individual unit of the area indicator 11 for independently converting an on/off state among the area indicator 11 may be referred to as a unit indicator. The unit indicator may be divided into a unit indicator 11b that is turned on and a unit indicator 11a that is turned off according to the electrical state.

The area indicator 11 may be disposed on the periphery of each of medicine insertion slots 12 or on a border between medicine insertion slots 12 adjacent to each other. Referring to FIG. 2, only the unit indicators 11b disposed on an outer line of a corresponding area R1 to indicate the area R1 including the medicine insertion slots adjacent to each other may be turned on. In this case, the remaining unit indicators 11a may be maintained in the turn-off state.

On the other hand, the unit indicator 11a may be converted in turn-on/off state. That is, after all unit indicators are maintained in the turn-on state, only the unit indicators disposed on the outer line of the corresponding area R1 may be converted into the turn-off state.

The unit indictors 11a and 11b according to the current embodiment may be provided in a pair between intersection points at which borders of the medicine insertion slots 12 cross P1 or contact P2 each other. Here, each of the unit indicators 11a and 11b may be disposed adjacent to the corresponding intersection point. As described above, each of the intersection point may indicate a straight line or a border between edges by a combination of the unit indicators.

As illustrated in FIG. 2, if it is assumed that medicines are inserted into the area R1, the unit indicators 11b disposed on the border of the area R1 may be turned on to allow a user to insert the medicines into the medicine insertion unit 12 within the corresponding area. Thus, the user may insert the medicines into each of the medicine accepting units 12 disposed in an area of the LED device that emits light. In this case, the user may recognize the border of the area R1 to complete a recognition process for inserting the medicines.

That is, when the LED device corresponding to each of the medicine accepting unit is individually attached like the related art, there are troubles in which the user checks whether the LED devices emit light one by one and recognizes the medicine accepting unit corresponding to the LED device that emits light. However, in the medicine insertion apparatus according to the current embodiment, the medicine insertion process may be performed just by recognizing the insertion area itself. Particularly, if the medicine insertion area is large, the above-described effect may be improved.

Also, as illustrated in FIG. 3, the area indicator 11 may indicate a plurality of areas R1 and R2 at the same time. Also, the area indicator 11 may indicate the medicine accepting units for inserting specific medicines on the basis of prescription data of at least two patients.

If the plurality of areas R1 and R2 are indicated once as described above, the areas R1 and R2 may overlap with each other. The unit indicators 11b that are turned on may emit light having different colors or brightness so as to indicate various information such as the overlapping of the areas R1 and R2. For example, when the overlapping of different areas occurs on a specific border during the indicating of the borders of the areas, the corresponding overlapping border line may be indicated with different colors or brightness to indicate the overlapping areas.

Also, as illustrated in FIG. 4, only the angular points of the specific area R1 may be indicated simply.

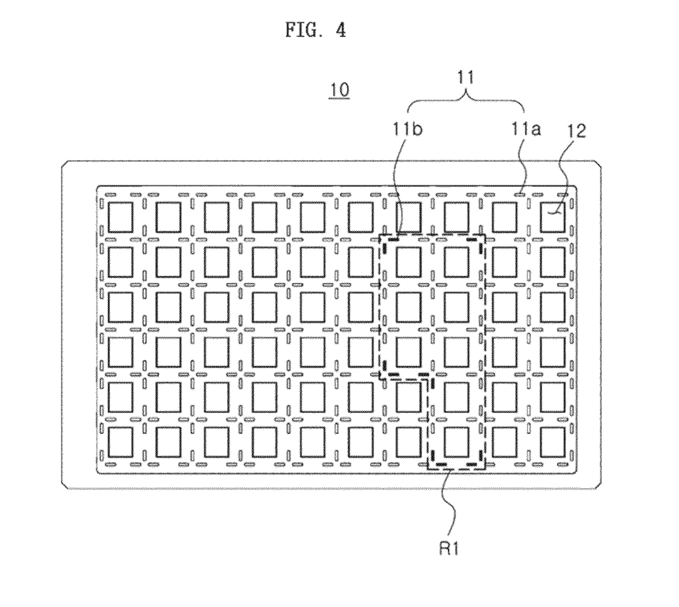

A medicine insertion apparatus according to another embodiment will be described with reference to FIG. 5. FIG. 5 is a plane view illustrating the medicine insertion apparatus according to another embodiment.

As illustrated in FIG. 5, an area indicator 11 may include one unit indicator 11a or 11b may be disposed between medicine accepting units 12 adjacent to each other. In this case, unlike the foregoing embodiment, the number of LEDs may be reduced.

As described above, the unit indicators may be provided on the periphery or a border line of each of the medicine accepting units through various methods. The indicating unit may continuously indicate the peripheral or border of the medicine accepting units, unlike the foregoing embodiments in which the above-described discontinuous border is indicated.

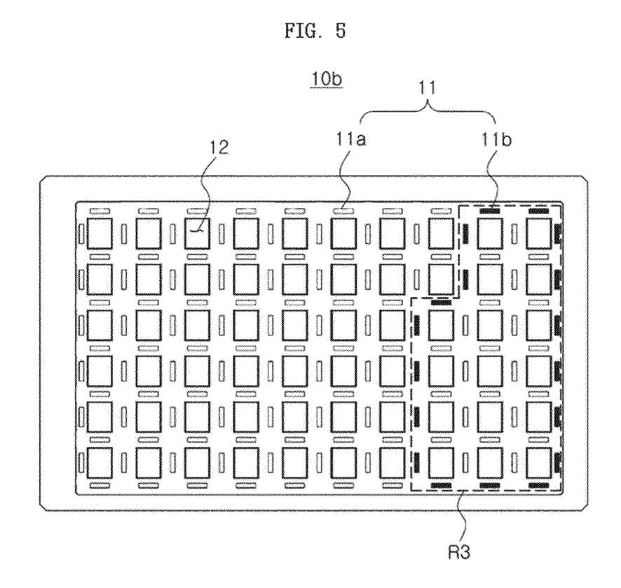

A medicine insertion apparatus according to an embodiment will be described with reference to FIG. 6. FIG. 6 is a perspective view illustrating a medicine insertion indicating apparatus according to an embodiment.

A medicine insertion indicating apparatus 10S according to the current embodiment may be seated in a skin type on a medicine insertion apparatus 10P that does not include a separate indicating unit to guide a position in which medicines are inserted.

Particularly, the medicine insertion indicating apparatus 10S according to the current embodiment includes an indicating apparatus body unit S13, a medicine insertion slot 12S, and an area indicator 11.

The indicating apparatus body unit 13S may have a square plate shape and be seated on the medicine insertion apparatus 10P. Also, a plurality of medicine insertion slots 12S are defined in the indicating apparatus body unit 13S. The medicine insertion slots 12S may be disposed to correspond to a plurality of medicine accepting units 12 disposed on the insertion apparatus body unit 13 when the indicating apparatus body unit 13S is seated on the insertion apparatus body unit 13. The indicating unit 11 may have the same constitution and function as the above-described indicating unit according to another embodiment.

That is, the medicine insertion indicating apparatus 10S may indicate areas in which specific medicines are inserted through the indicating unit 11 disposed on a border of each of the medicine insertion slots 12S. When a user inserts medicines into the indicated area, the corresponding medicines may be inserted into a target medicine accepting unit 12 through the medicine insertion slot 12S.

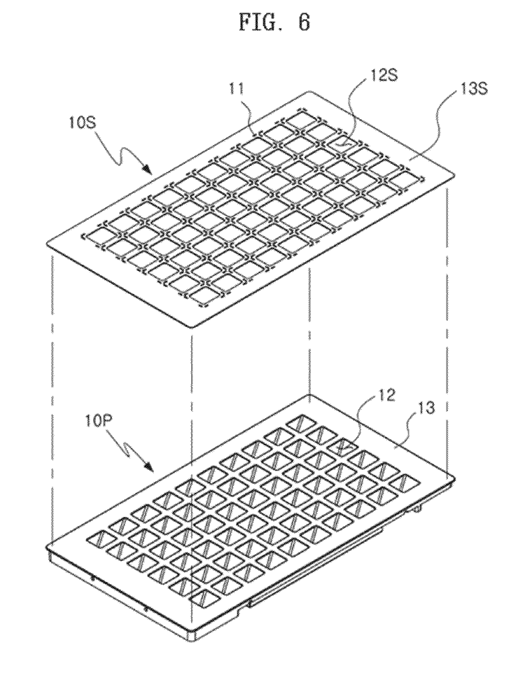

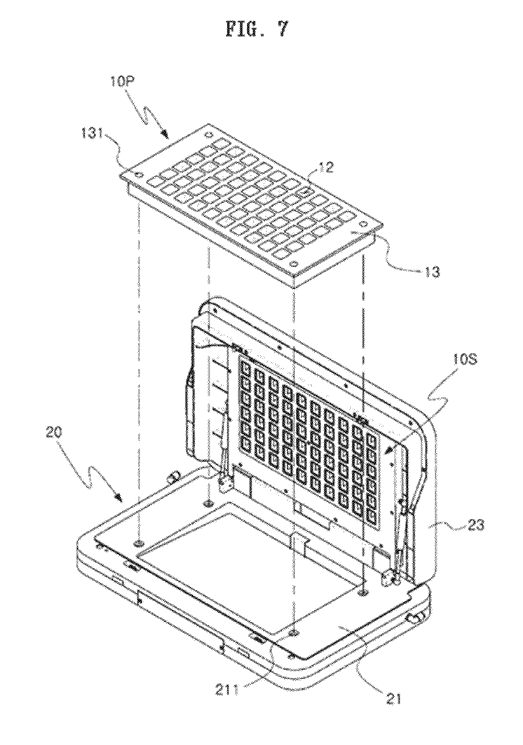

A medicine insertion indicating apparatus according to another embodiment will be described with reference to FIGS. 7 and 8. FIG. 7 is an exploded perspective view of a medicine insertion indicating apparatus according to another embodiment, and FIG. 8 is a perspective view illustrating a use state of the medicine insertion indicating apparatus of FIG. 7.

A medicine insertion indicating apparatus 10P according to the current embodiment may have the same constitution as the medicine insertion indicating apparatus of FIG. 6. However, the current embodiment is different from the foregoing embodiment in that a medicine insertion indicating apparatus 10S is disposed on the medicine insertion apparatus 10S through a separate unit.

That is, in the current embodiment, an insertion auxiliary unit 20 for locating the medicine insertion indicating apparatus 10S and the medicine insertion apparatus 10P at adequate positions may be further provided. The insertion auxiliary unit 20 includes a seating part 21 and a cover part 23. When the medicine insertion apparatus 10P is seated on the seating part 21, the medicine insertion indicating apparatus 10S is fixed to the cover part 23. Here, a guide part 211 having a groove shape is defined in the seating part 21, and a part 131 to be guided (hereinafter, referred to as a “guided part”) having a downwardly protruding shape may be disposed on the medicine insertion apparatus 10P. Since the guided part 131 is inserted into the guide part 211, the medicine insertion apparatus 10P may be disposed in regular position on the seating part 21.

Thereafter, when the cover part 23 covers the seating part 21, the medicine insertion apparatus 10P and the medicine insertion indicating apparatus 10S may be respectively disposed on upper and lower portions with respect to each other as illustrated in FIG. 6. Then, the user as a pharmacist may insert medicines into a predetermined area according to the guide of the area indicator 11.

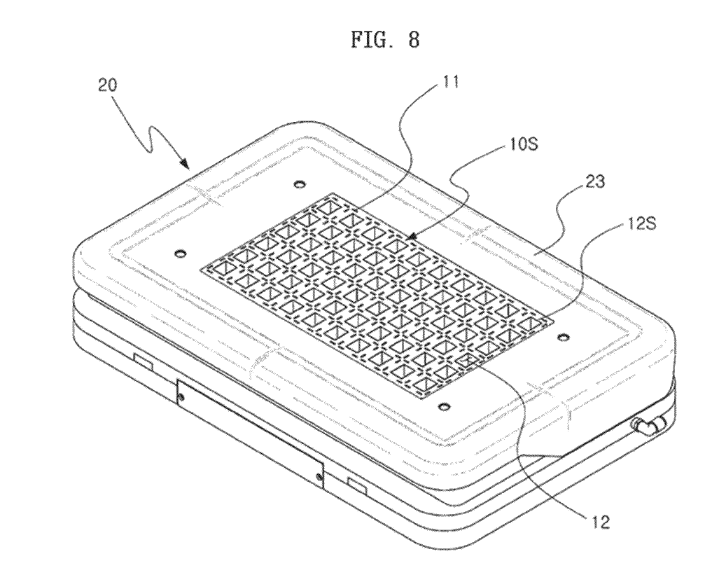

A medicine auto-packaging apparatus according to an embodiment will be described with reference to FIG. 9. FIG. 9 is a perspective view of a medicine auto-packaging apparatus according to an embodiment.

A medicine auto-packaging apparatus 100 includes a medicine cassette 110, a medicine insertion apparatus 10, a transferring unit 120, and a packaging unit 130. The medicine cassette 110 may be provided in plurality. Here, the plurality of medicine cassette 110 may store various kinds of medicines and then dispense the medicines by a specific amount of medicine according to a control signal.

The medicine insertion apparatus 10 may include an area indicator to indicate an area, in which the medicines are inserted, to the pharmacist, like the embodiment of FIG. 1. The pharmacist may manually insert drugs that are not previously stored in the medicine cassette 110.

The transferring unit 120 may collect medicines that are dispensed after being inserted into the medicine cassette 110 and the medicine insertion apparatus 10 to successively transfer the dispensed medicines toward a packaging unit 130. The packaging unit 130 may automatically package the medicines successively transferred from the transferring unit 120.

The medicine insertion apparatus 10 may be a portion of the medicine auto-packaging apparatus 100, i.e., be integrated with the medicine auto-packaging apparatus 100. Also, the medicine insertion apparatus 10 of FIG. 1 may be selectively attached to the medicine auto-packaging apparatus 100 as necessary.

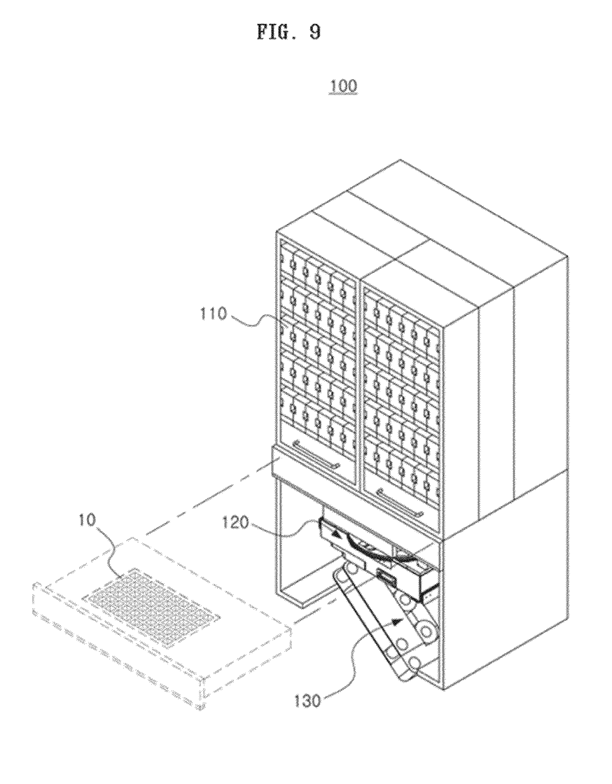

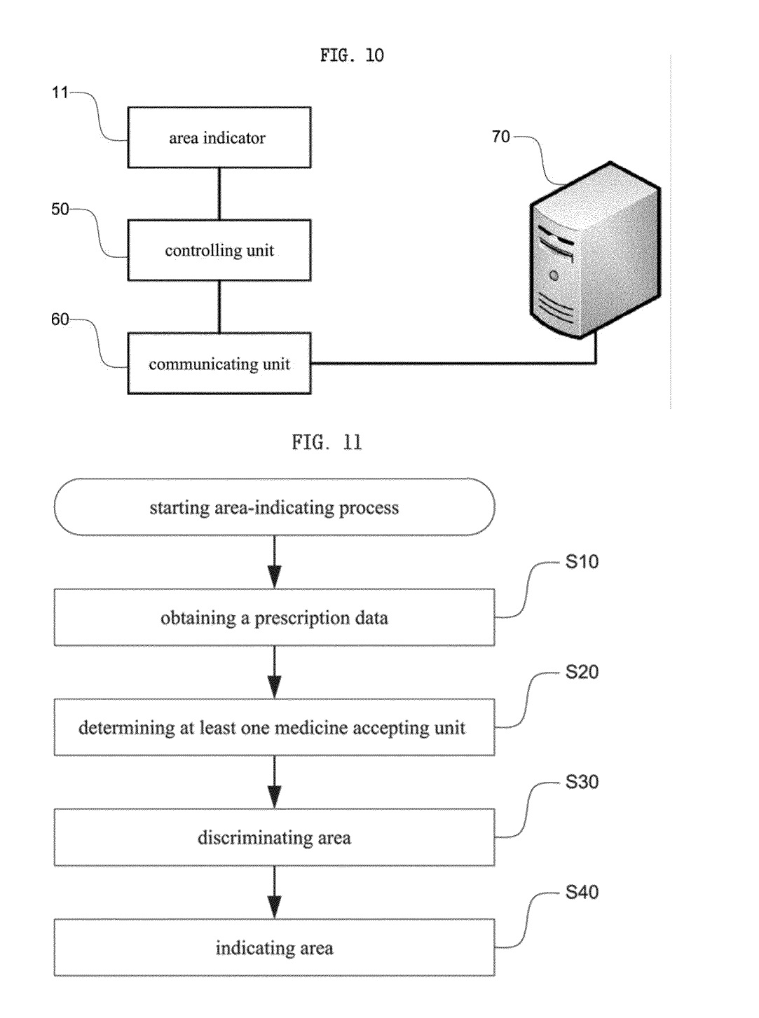

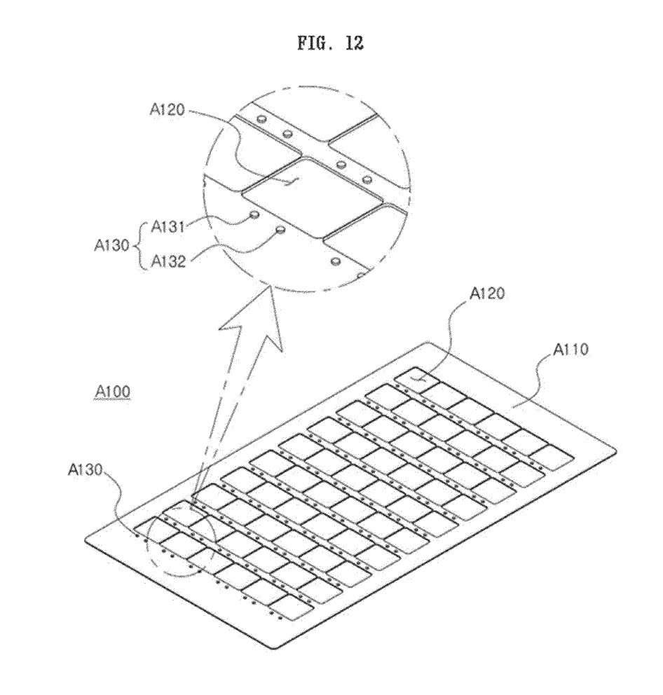

A method for indicating a medicine insertion area according to an embodiment will be described with reference to FIGS. 10 and 11. FIG. 11 is a flowchart illustrating a method for indicating a medicine insertion area according to an embodiment, and FIG. 12 is a perspective view of the medicine insertion indicating apparatus according to an embodiment.

As illustrated in FIG. 10, a control unit according to the current embodiment may receive prescription data from an external device 70 through a communication unit 60. The control unit 50 may control an area indicator 11 so that the area indicator 11 indicates a predetermined area through a series of processes. Here, the communication unit 60 and the external device 70 may be realized in various shapes according to embodiments. For example, in the case of the embodiment described with reference to FIG. 1, the external device 70 may be an external server for managing the prescription data, and the communication unit 60 may be a wireless or wired communication terminal provided in the medicine insertion apparatus. When the communication unit 60 and the external device 70 are realized as a portion of the medicine auto-packaging apparatus, the external device 70 may be a computing device provided in the corresponding medicine auto-packaging apparatus, and the communication unit 60 may be a communication port communicating with the corresponding computing device.

As illustrated in FIG. 11, the control unit 50 may control the area indicator 11 to indicate a predetermined area through prescription data acquisition (S10), medicine accepting unit determination (S20), area classification (S30), and area indication (S40).

In the prescription data acquisition (S10), the control unit 50 receives prescription data of at least one patient from the external device 70 through the communication unit 60.

Then, in the medicine accepting unit determination (S20), medicine accepting units in which specific medicines are inserted on the basis of the prescription date of the at least one patient, which is treated one time, are determined. For example, if it is intended to distribute medicines C and D to patients A and B according to the prescription data, the medicine accepting unit in which the medicines C are inserted is determined according to a taking period for the medicines C to the patients A and B. Then, after the area indication (S40) is completely finished, the same process may be performed again with respect to medicines D.

In the area classification (S30), the areas adjacent to each other are classified according to the positions of the determined medicine accepting units. That is, the medicine accepting units to be indicated as one area may be determined in consideration of the positions of the medicine accepting units in which the medicines C are inserted.

Finally, in the area indicating (S40), the control unit controls the area indicator to indicate areas of the medicine accepting units in which the medicines C are inserted.

Hereinafter, a medicine insertion indicating apparatus and a control method thereof according to another embodiment of the present invention will be described.

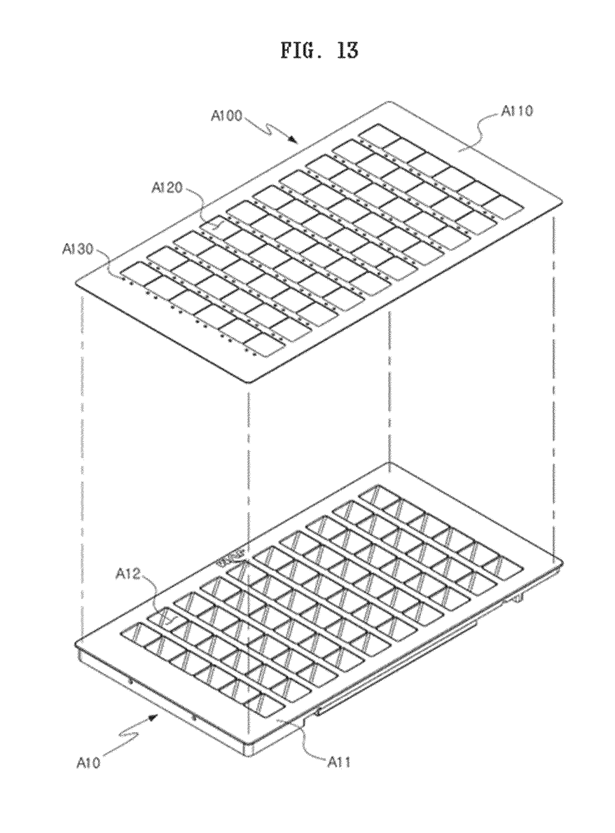

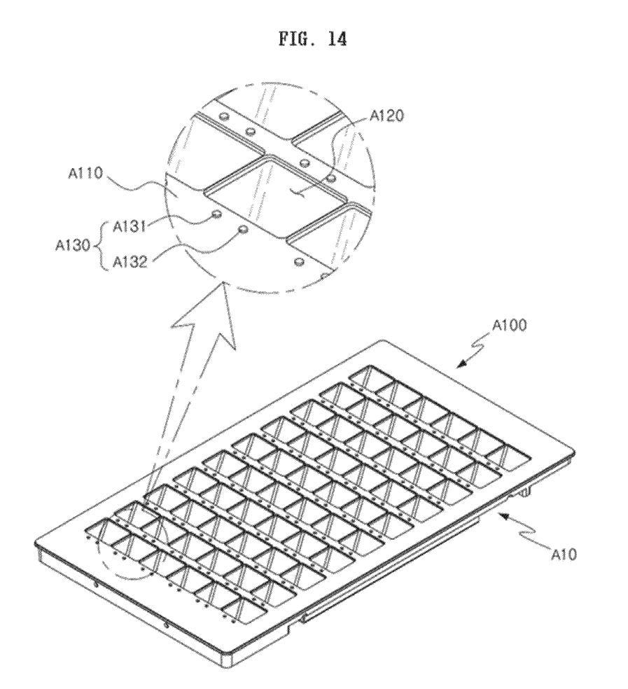

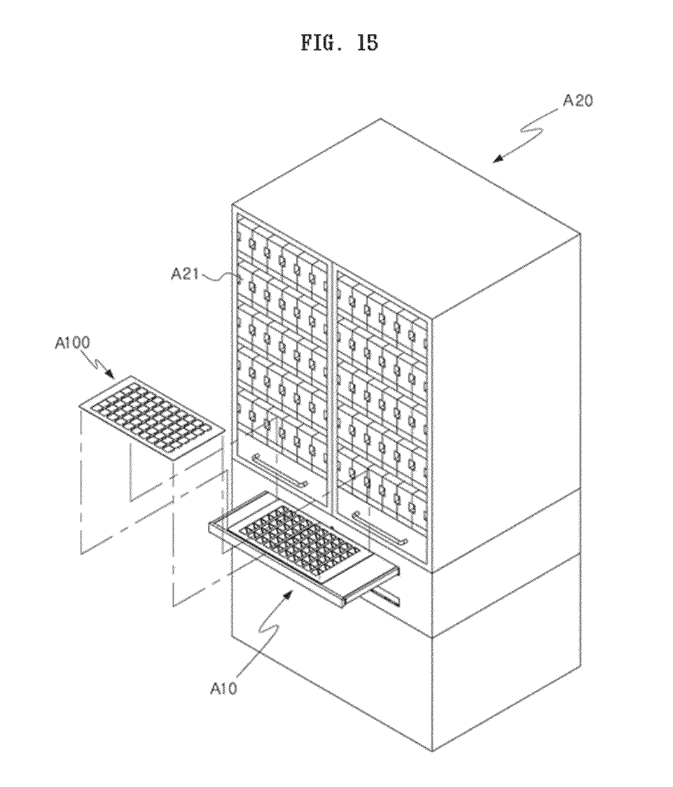

A medicine insertion indicating apparatus according to an embodiment of the present invention will be described with reference to FIGS. 12 to 16. FIG. 12 is a perspective view of the medicine insertion indicating apparatus according to an embodiment, and FIG. 13 is a perspective view of the medicine insertion indicating apparatus and a medicine tray according to an embodiment. FIG. 14 is a perspective view illustrating a state in which the medicine insertion indicating apparatus is coupled to the medicine tray according to an embodiment, and FIGS. 15 and 16 are perspective views illustrating a state in which the medicine insertion indicating apparatus is coupled to the medicine tray provided in the medicine auto-packaging apparatus according to an embodiment.

Referring to FIG. 12, a medicine insertion indicating apparatus A100 according to the current embodiment includes a medicine insertion indicating apparatus 100A, a body unit A110, a medicine insertion slot A120, and an indicating unit A130.

The body unit A110 according to the current embodiment may have a square plate shape on the whole. The body unit A110 may be formed of various materials such as a flexible material and a hardened synthetic resin material. However, for convenience in storage, the body unit A110 may be formed of the flexible material. A plurality of medicine insertion slots A120 that passes from a top surface of the body unit A110 to a bottom surface of the body unit A110 may be defined in the body unit A110.

The medicine insertion slots A120 may be through-holes which are defined in the body unit A110 to insert medicines therethrough. Also, the medicine insertion slots A120 may be arranged in a plurality of rows and columns. Although each of the medicine insertion slots A120 according to the current embodiment has a square shape to pass through the body unit A110, the present invention is not limited thereto. For example, if the medicine insertion slot A120 has a sufficient size and shape to allow target medicines to be inserted, the medicine insertion slot A120 may not be limited in shape and size.

An indicating unit A130 corresponding to each of the medicine insertion slot A120 may be disposed on the periphery of each of the medicine insertion slots A120. The indicating unit A130 may be disposed adjacent to the corresponding medicine insertion slot A120. The indicating unit A130 includes a first light emitting device A131 for indicating the medicine insertion slot A120 in which medicines are inserted according to the indicated state. Also, the indicating unit A130 may further include a second light emitting device A132 for indicating information related to the corresponding medicine insertion slot A120 as necessary. That is, the indicating unit A130 may include various light emitting devices for indicating various information related to the corresponding medicine insertion slots A120 in addition to the first light emitting device A131.

The first light emitting device A131 may indicate information with respect to whether medicines are inserted into the corresponding medicine insertion slot A120 according to the indicated state. For example, that specific medicines have to be inserted into only the medicine insertion slots A120 corresponding to the first light emitting devices A131 that are turned off may be indicated. Alternatively, that specific medicines have to be inserted into only the medicine insertion slots A120 corresponding to the first light emitting devices A131 that are turned on may be indicated. For another example, specific medicines may be inserted into only the medicine insertion slots A120 corresponding to the first light emitting devices A131 that are indicated with a first color. Also, the specific medicines may not be inserted into the medicine insertion slots A120 corresponding to the first light emitting devices A131 that are indicted with a second color, or other specific medicines may be inserted into the medicine insertion slots A120 corresponding to the first light emitting devices A131 that are indicted with the second color.

Referring to FIG. 13, the medicine insertion indicating apparatus A100 according to the current embodiment is seated on a medicine tray A10. The medicine tray A10 includes a tray body A11 and a medicine accepting unit A12.

The tray body A11 may constitute an external housing of the medicine tray A10.

As described above, medicines may be inserted and stored in the medicine accepting unit A12. Then, as occasion demands, when a bottom surface of the medicine accepting unit A12 may be opened, the stored medicines may simultaneously or successively drop down and thus be supplied. The medicine accepting unit A12 may have a concave groove shape and a sufficient size for accepting the inserted medicines. The medicine accepting unit A12 may be provided in plurality. Here, the plurality of medicine accepting units A12 may be arranged in a plurality of rows and columns. The medicine accepting units A12 may be disposed at positions that one to one correspond to those of the medicine insertion slots A120 of the above-described medicine insertion indicating apparatus A100.

Referring to FIG. 14, when the medicine insertion indicating apparatus A100 is seated on the medicine tray A10, as described above, the medicine insertion slots A120 of the medicine insertion indicating unit A100 and the medicine accepting units A12 of the medicine tray A10 may be disposed at positions that one to one correspond to each other to allow the medicines inserted through the medicine insertion slots A120 to be accepted into the medicine accepting unit A12 of the medicine tray A10. As described above, each of the indicting units A130 may be disposed to correspond to one medicine insertion slot A120. Thus, when the medicines are inserted into the medicine insertion slot A120 that is guided by the indicating unit A130, the medicines may be accepted into the medicine accepting unit A12 corresponding to the corresponding medicine insertion slot A120 through the corresponding medicine insertion slot A120.

There are various embodiments with respect to the medicine tray A10. That is, the medicine insertion indicating apparatus A100 may be seated on a medicine tray A10a provided in the medicine auto-packaging apparatus illustrated in FIGS. 15 and 16 in addition to the above-described independent medicine tray A10.

The medicine auto-packaging apparatus A20 may include a medicine cassette A21, a medicine tray A10a, and a packaging unit (not shown). The medicine auto-packaging apparatus A20 may be an apparatus for packaging the medicine dispensed from the medicine cassette A21 or the medicine tray A10a by a single-dose amount according to a patient's prescription. The packaging unit may package the medicines, which are dispensed from the medicine cassette A21 and the medicine tray A10a and then collected through a structure such as a hopper, into a packaging paper.

Although the medicine tray A10a provided in the medicine auto-packaging apparatus A20 may be fixed, the above-described independent medicine tray (see reference numeral A10 in FIGS. 13 and 14) may be mounted. As illustrated in FIG. 16, an indicating unit A130 may operate to guide a corresponding medicine insertion slot A120 corresponding to one medicine tray A10a regardless of the type of fixed or independent medicine tray.

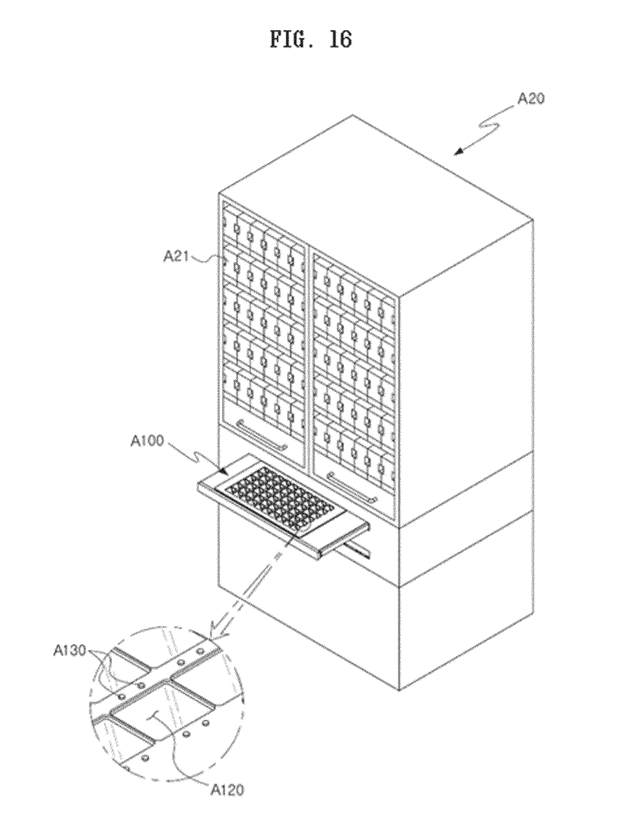

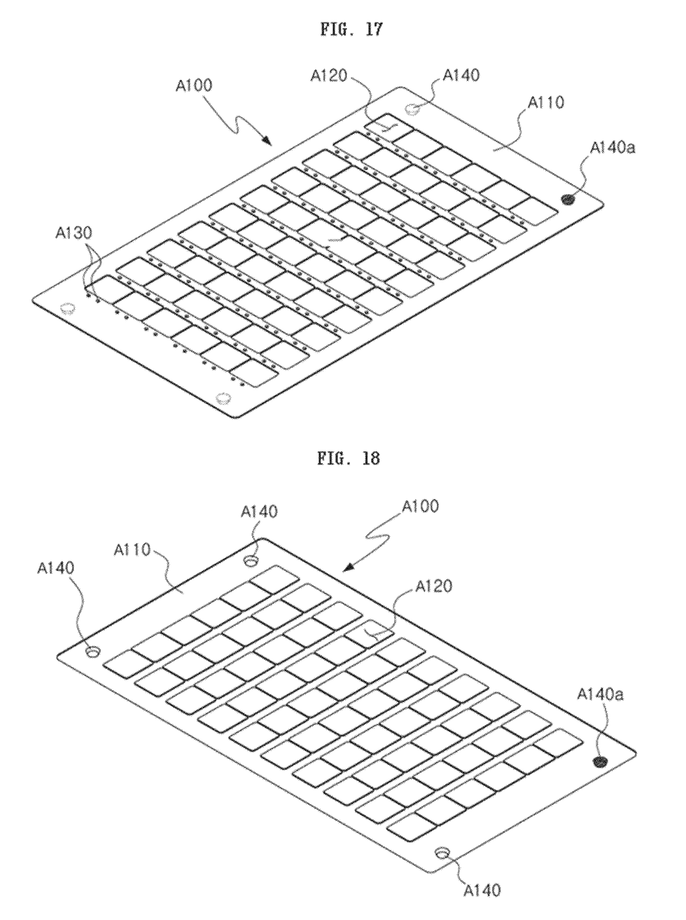

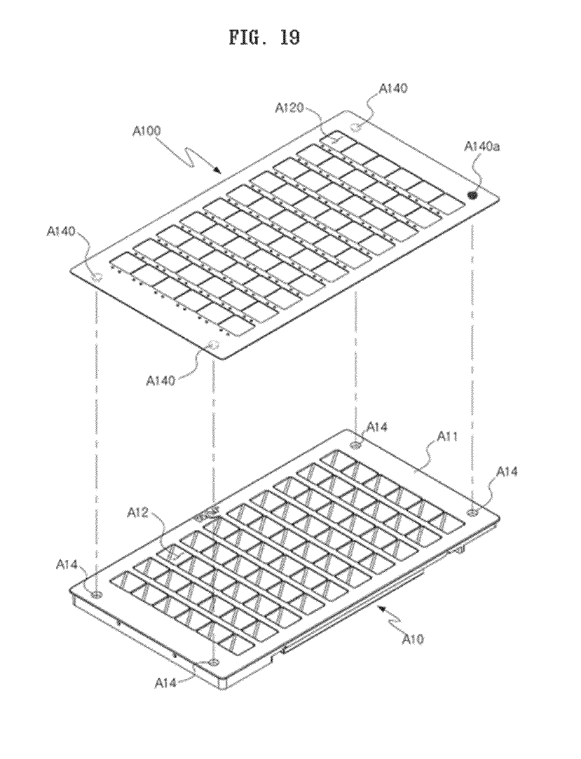

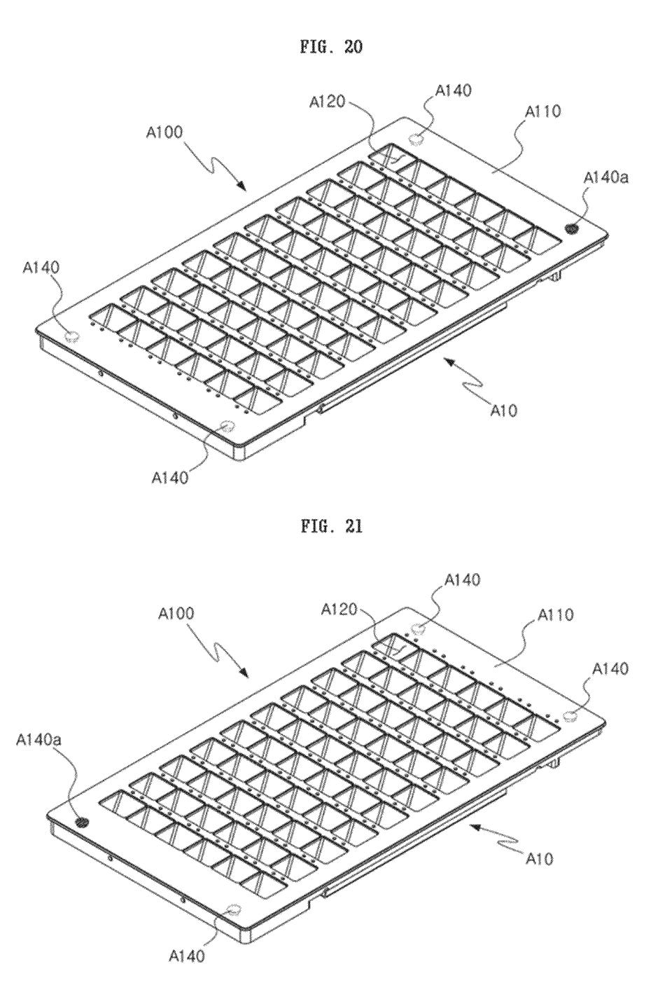

A medicine insertion indicating apparatus according to another embodiment will be described with reference to FIGS. 17 and 21. FIG. 17 is a perspective view of a medicine insertion indicating apparatus including a sensed part according to another embodiment, and FIG. 18 is a bottom perspective view of the medicine insertion indicating apparatus of FIG. 17. FIGS. 19 and 20 are perspective views illustrating a state in which the medicine insertion indicating apparatus of FIG. 17 is seated on the medicine tray that corresponds thereto, and FIG. 21 is a perspective view illustrating a sate in which the medicine insertion indicating apparatus of FIG. 17 is seated on the medicine tray in a different direction.

The medicine insertion indicating apparatus according to the current embodiment may be different from the foregoing embodiment in that a guide part and a part to be sensed (hereinafter, referred to as a sensed part) (or a sensing part) are provided.

A medicine insertion indicating apparatus A100a according to the current embodiment may include a first guide part A140 protruding from a bottom surface of a medicine tray as illustrated in FIGS. 17 and 18. Here, one of the guide parts may be a sensed part A140a that includes a magnet that is built therein as one body and thus is sensed by a separate sensor. Although the sensed part and the guide part are integrated with each other in the current embodiment, the sensed part and the guide part may be independently provided.

Referring to FIG. 18, the first guide part A140 and the sensed part A140a may protrude downward from the bottom surface of the medicine insertion indicating apparatus A100. Although the first guide part A140 and the sensed part A140a according to the current embodiment are disposed on edges of a body unit A110, the first guide part A140 and the sensed part A140a may be disposed on any portions of four sides defining edges of the body unit A110. In general, although the plurality of guides may be disposed asymmetrical to each other so that the guides are coupled or seated at accurate positions or in accurate directions, the first guide part A140 and the sensed parts A140a according to the current embodiment may be disposed point-symmetrical or line-symmetrical to each other because the first guide part A140 and the sensed part A140a automatically recognize the medicine insertion indicating apparatus A100 even though the medicine insertion indicating apparatus A100 horizontally rotates and then is seated in a different direction.

Referring to FIGS. 19 and 20, a first guide part A14 disposed with numbers and at positions, which correspond to total number of first guide part A140 and the sensed part A140a are disposed on the medicine tray A10. The second guide part A14 may have a shape corresponding to the first guide part A140. For example, when the first guide part A140 has a protruding shape, the second guide part A14 may have a groove shape for accommodating the first guide part A140. On the other hand, when the first guide part A140 has a groove shape, the second guide part A14 may have a protruding shape that is accommodated into the first guide part A140.

A sensing part (not shown) may be disposed on a lower end of the second guide part A14 in which the sensed part A140a of the second guide part A14 is inserted. For example, the sensed part A140a may be inserted into a 2nd second guide part A14-2 in a clockwise direction from 12 o'clock direction among total four second guide parts A14 illustrated in FIG. 19. Also, when the medicine insertion indicating apparatus A100 horizontally rotates at an angle of about 180 degrees, the sensed part A140a may be inserted into a 4rd second guide part A14-4 in the clockwise direction from the 12 o'clock direction. In this case, a sensing part for sensing the sensed part A140a may be disposed on each of the above-described 2nd and 4rd second guide parts A14-2 and A14-4. The sensing part may sense a state in which the sensed part A140a is inserted into or close to the second guide part A14. The sensing part and a kind of sensor that is used for the sensing part will be described below in detail.

In a state where the first guide part A140 and the sensed part A140a are respectively accommodated to correspond to the second guide parts A14, the medicine insertion indicating apparatus A100 may be seated on the medicine tray A10. In this case, the medicine insertion indicating apparatus A100 may be seated in two directions as illustrated in FIGS. 20 and 21. Here, as described above, the sensing part for sensing the sensed part A140a of the two sensing parts may be identified to accurately sense the seated direction of the medicine insertion indicating apparatus A100.

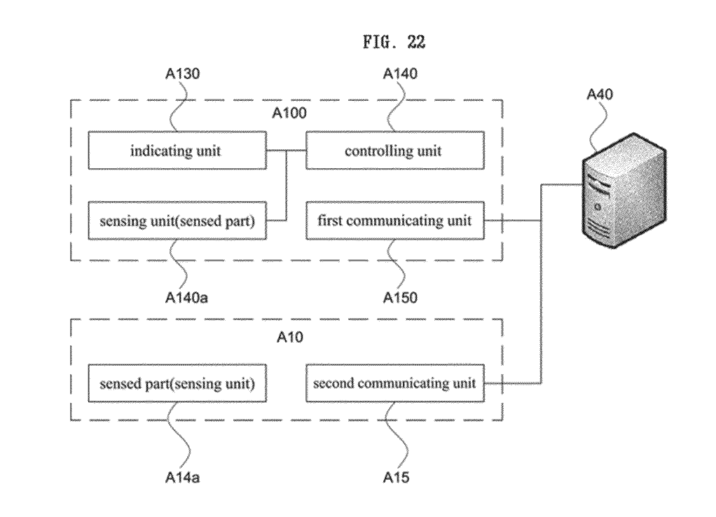

An electrical constitution and a connection relationship of the medicine insertion indicating apparatus will be described with reference to FIG. 22. FIG. 22 is a block diagram illustrating an electrical constitution and a connection relationship of the medicine insertion indicating apparatus according to an embodiment.

A first communication unit A150 and a second communication unit A15 may be units for transmitting and receiving data into/from an external server 40, and also, their detailed descriptions will be omitted.

As described above, the sensing part and the sensed part that correspond to each other may be disposed on the medicine insertion indicating apparatus A100 and the medicine tray A10. When the sensing part is disposed on the medicine insertion indicating apparatus A100, the sensed part may be disposed on the medicine tray A100 to sense a direction in which the medicine insertion indicating apparatus A100 is seated on the medicine tray A10. Also, when the medicine insertion indicating apparatus A100 is disposed on the sensed part, the sensing part may be disposed on the medicine tray A10 to sense a direction in which the medicine insertion indicating apparatus A100 is seated on the medicine tray A10.

Hereinafter, each of the above-described two cases, i.e., the sensing part and the sensed part are provided will be described with respect to the control unit A140.

First, when the sensing part is disposed on the medicine insertion indicating apparatus A100, and the sensed part is disposed on the medicine tray A10, the control unit A140 may receive information with respect to a prescription, i.e., information with respect to a medicine accepting unit, in which specific medicines are inserted, from the external server 40. Also, the control unit A140 may receive a signal from the sensing part sensing the sensed part of the medicine tray A10 of the sensing parts to determine a direction in which the medicine insertion indicating apparatus A100 is seated on the medicine tray A10. Thereafter, the control unit A140 may recognize the direction of the medicine insertion indicating apparatus A100 to match a medicine insertion slot of the medicine insertion indicating apparatus A100 with the medicine accepting unit of the medicine tray A10, thereby controlling the indicating unit A130 so as to guide the medicine insertion slot in which the medicines are inserted.

Then, when First, when the sensed part is disposed on the medicine insertion indicating apparatus A100, and the sensing part is disposed on the medicine tray A10, the control unit A140 may receive information with respect to a prescription, i.e., information with respect to the medicine accepting unit, in which specific medicines are inserted, and identification data (or data with respect to the seated direction of the medicine insertion indicating apparatus A100) of the sensing part sensing the sensed part of the medicine insertion indicating apparatus A100 among the sensing parts of the medicine tray A10 from the external server 40. The control unit A140 may put the received prescription information and the information with respect to the seated direction together to match the medicine insertion slot of the medicine insertion indicating apparatus A100 with the medicine accepting unit of the medicine tray A10, thereby controlling the indicating unit A130 so as to guide the medicine insertion slot in which the medicines are inserted.

Alternatively, the medicine insertion indicating apparatus A100 may directly receive the identification data (the data with respect to the seated direction of the medicine insertion indicating apparatus A100) of the sensing part sensing the sensed part of the medicine insertion indicating apparatus A100 among the sensing parts of the medicine tray A10 from the medicine tray A10 without using the external server 40.

As described above, the sensing part and the sensed part may be realized by using various sensors such as a mechanical switch, an electrical sensor, a proximity sensor, an optical sensor, a magnetic sensor, and the like. For example, the sensors may include a switch (the sensing part) operating by the insertion of the guide part (the sensed part), a light emitting part (the sensed part) and a light receiving part (the sensing part) for sensing light emitted from the light emitting part, a magnet (the sensed part), and a magnetic sensor (the sensing part).

The embodiment with respect to the sensed part and the sensing part which are described with reference to FIGS. 20 and 21 may be applied to the medicine insertion indicating apparatus 10S that is described with reference to FIG. 6. Therefore, the method in which the seated direction of the medicine insertion indicating apparatus 10S may be sensed to adequately control an operation of the light emitting device may be applied.

According to the present invention, the medicine accepting unit or medicine inserting slot in which medicines are inserted may be guided and thus easily recognized when the medicines are manually inserted to previously prevent the medical accident such as the packaging error from occurring.

Also, according to the present invention, the medicine accepting unit or medicine insertion slots in which medicines are inserted may be divided into predetermined areas and then indicated to reduce the number of recognition steps required for inserting the medicines. That is, when medicines are successively inserted into the medicine accepting unit or the medicine insertion slot, which are continuously disposed within the medicine insertion area, only recognition determined that the medicine accepting unit or the medicine insertion slot exists within the area may be sufficient. Thus, since it is unnecessary to determine whether the medicines have to be inserted into the medicine accepting unit or the medicine insertion slot one by one, the risk in the medicine packaging error may be minimized.

While this invention has been particularly shown and described with reference to preferred embodiments thereof, it will be understood by those skilled in the art that various medicine insertion indicating apparatuses, medicine insertion apparatuses, medicine auto-packaging apparatuses including the same, and medicine insertion area indicating method thereof may be made therein without departing from the spirit and scope of the invention as defined by the appended claims.

What is claimed is:

1. An apparatus for inserting medicines, the apparatus comprising:
a plurality of medicine insertion slots; and
an area indicator configured to indicate an area including at least one medicine insertion slot among the plurality of medicine insertion slots,
wherein the area indicator comprises at least two unit indicators which indicates the area in combination.

2. The apparatus of claim 1, wherein the area indicator indicates at least one area defined by the adjacent medicine insertion slots of the plurality of medicine insertion slots along an outer line of each of the areas.

3. The apparatus of claim 1, wherein the area indicator comprises at least one of the unit indicators disposed on borders between the medicine insertion slots.

4. The apparatus of claim 3, wherein at least one of the unit indicators is disposed between intersection points adjacent to each other among intersection points at which the borders cross or contact each other.

5. The apparatus of claim 4, wherein the unit indicator comprises each of the unit indicating units adjacent to each of the intersection points.

6. The apparatus of claim 3, wherein the plurality of medicine insertion slots are divided for patients and taking periods.

7. The apparatus of claim 6, further comprising a control unit determines the medicine insertion slots, in which specific medicines are inserted, of the plurality of medicine insertion slots according to patient's prescription date transmitted from an external device and controls the area indicator to indicate areas of the determined medicine insertion slots.

8. The apparatus of claim 7, wherein the control unit controls the area indicator to indicate the areas, in which the specific medicines are inserted with respect to the plurality of patients, at the same time.

9. The apparatus of claim 3, wherein the unit indicator comprises a light emitting device.

10. An apparatus for auto-packaging medicines, the apparatus comprising:
a medicine insertion apparatus configured to include a plurality of medicine insertion slots and an area indicator configured to indicate an area including at least one medicine insertion slots among a plurality of medicine insertion slots,
wherein the area indicator comprises at least two unit indicators which indicates the area in combination;
a transferring unit configured to transfer the medicines inserted in the medicine insertion apparatus; and
a packaging unit configured to package the medicines transferred by the transferring unit.

11. An apparatus for indicating, among a plurality of medicine accepting units which are included in a medicine insertion apparatus, at least one medicine accepting unit to which medicines are to be inserted, the apparatus comprising:
an indicating apparatus body unit configured to be disposed on the apparatus;
a plurality of medicine insertion slots configured to be formed at the indicating apparatus body unit and to be formed to respectively correspond to each of the plurality of medicine accepting units when the indicating apparatus body unit disposes on a medicine tray; and
an area indicator configured to indicate an area including at least one medicine insertion slot among the plurality of medicine insertion slots,
wherein the area indicator comprises at least two unit indicators which indicates the area in combination.

12. The apparatus of claim 11, wherein the area indicator indicates at least one area defined by the adjacent medicine insertion slots of the plurality of medicine insertion slots along an outer line of each of the areas.

13. The apparatus of claim 11, wherein the indicating unit comprises at least one of the unit indicators disposed on borders between the medicine insertion slots.

14. The apparatus of claim 13, wherein at least one of the unit indicators is disposed between intersection points adjacent to each other among intersection points at which the borders cross or contact each other.

15. The apparatus of claim 14, wherein at least one of the unit indicators is located adjacent to each of the intersection points.

16. The apparatus of claim 11, further comprising a control unit determines the medicine insertion slots, in which specific medicines are inserted, of the plurality of medicine insertion slots according to patient's prescription date transmitted from an external device and controls the area indicator to indicate areas of the determined medicine insertion slots.

17. A method for indicating a medicine insertion area; the method comprising:
determining, among a plurality of medicine accepting units which are included in a medicine insertion apparatus, at least one medicine accepting unit to which a specific medicine is to be inserted based on patient prescription data;
discriminating at least one area comprising at least one medicine accepting unit which are adjacent to each other from the determined at least one medicine accepting unit;
determining at least one medicine accepting unit which is placed nearby a border of the determined area; and
indicating the determined area using an area indicator placed on a border of the at least one medicine accepting unit which is placed nearby a border of the determined area.

18. The method of claim 17, wherein, in the indicating of the determined area, the borders of the determined areas are continuously or discontinuously indicated by using the area indicator.

19. The method of claim 17, wherein, in the indicating of the determined area, angular points of the borders of the determined areas are indicated by using the indicating unit.
